(19) United States
(12) Patent Application Publication
(10) Pub. No.: US 2007/0035535 A1
(43) Pub. Date: Feb. 15, 2007

(54) Apparatus and method for compensating for image distortion of display apparatus

(75) Inventors: Young-ho Lee, Yongin-si (KR); Ki-hyun Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/495,754

(22) Filed: Jul. 31, 2006

(30) Foreign Application Priority Data
Aug. 13, 2005 (KR) 10-2005-0074566

(51) Int. Cl. G09G 5/00

(52) U.S. Cl. 345/204

(57) ABSTRACT

A method and apparatus for compensating for image distortion, which compensate for a difference between an input image signal and an output image signal of a display apparatus, are provided. An apparatus for compensating for distortion of an image which is output from a display unit for an image display apparatus includes an image reading unit which reads an output image which is output from the display unit, an image comparison unit which estimates a difference between image characteristics of the read output image and image characteristics of an input image and creates compensation information which compensates for the difference, and a compensation unit which compensates for distortion of the output image by correcting an original image using the compensation information.

### CROSS-REFERENCE TO RELATED PATENT APPLICATION

This application claims the priority from Korean Patent Application No. 10-2005-0074566, filed on Aug. 13, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to a display apparatus, and more particularly, a method

and apparatus which compensates for image distortion, which compensate for a difference between an input image signal and an output image signal of a display apparatus.

2. Description of the Related Art

A display apparatus such as a liquid crystal display apparatus commonly includes upper and lower substrates, a liquid crystal panel composed of a liquid crystal infused between the upper and lower substrates, a driving circuit which drives the liquid crystal panel, and a backlight unit which provides white light onto the liquid crystal. Methods of representing a color image on the liquid crystal display apparatus can be classified into an RGB color filter method and a color field sequential drive method.

In a liquid crystal display apparatus using the color filter method, a pixel is separated into red green and blue (RGB) unit pixels, RGB color filters are arranged to correspond to the RGB unit pixels, respectively, and light is transferred to the RGB color filters through the liquid crystal by the backlight unit, thereby forming a color image.

In a liquid crystal display apparatus using the color field sequential drive method, RGB light sources are arranged to correspond to one pixel which is not separated into RGB unit pixels, and light of the three primary colors R, G, and B of the RGB backlight is sequentially displayed on the pixel through the liquid crystal in a time division manner, thereby displaying a color image using an afterimage effect.

FIG. 1 is a view of a basic method of driving a backlight of a field sequential display apparatus according to the related art.

Referring to FIG. 1, one image field is divided into RGB sub-fields to be displayed on a screen. Specifically, R data is first displayed on a liquid crystal panel. That is, a light source R is turned on after the liquid crystal is completely activated. The light source R is then turned off to display G data on the liquid panel. Then a light source G is turned on after the liquid crystal is completely activated. The light source G is then turned off to display B data on the liquid panel. Then a light source B is turned on after the liquid crystal is completely activated. All the RGB sub-fields are displayed in this way thereby forming one screen. However, in the basic method of driving the backlight of FIG. 1, the backlight has a short turn-on time due to an image data input and response time of the liquid crystal, which leads to contrast deterioration. Therefore, to solve this problem, a driving method using a scrolling backlight has been introduced.

FIG. 2 is a view of a driving method using a scrolling backlight of a field sequential display apparatus according to the related art.

Referring to FIG. 2, in the driving method using the scrolling backlight, a screen is divided into areas, and light sources corresponding to the respective areas are respectively driven. Namely, a light source is first driven for an area where the liquid crystal is activated, and other color light sources are driven for other areas. A light source using the driving method using the scrolling backlight can have a greater turn-on time than a basic method of driving the backlight. However, in the scrolling backlight driving method, color purity may deteriorate due to color mixture between light sources, since light sources of different colors are concurrently turned on for one screen. To solve this problem, a barrier rib (separating rib) may be placed between separately driven areas to prevent interference between respective light sources.

FIG. 3 is a schematic cross-sectional view of a display apparatus including a barrier rib preventing color mixture according to the related art. FIG. 4 is an example of an image displayed on a display apparatus of FIG. 3.

Referring to FIG. 3, a display apparatus includes an R light source 1, a G light source 2, and a B light source 3. A barrier rib 10 is placed between each light source to prevent light from the respective light sources from mixing with each other. However, if the barrier rib is used to prevent the color mixture, luminance may vary when a portion where the barrier rib is placed has less light than other portions. Referring to FIG. 4, a portion 20 where the barrier rib is placed has less light than other portions, which leads to varying luminance and image quality deterioration.

### SUMMARY OF THE INVENTION

The present invention provides a method and apparatus for compensating image distortion, which output an image closely resembling an original input image by compensating image distortion of a display apparatus.

The present invention also provides a method and apparatus for compensating image distortion, in which image quality of a liquid crystal display apparatus can be improved by removing varying luminance which may occur on a panel of the liquid crystal display apparatus.

According to an aspect of the present invention, there is provided an apparatus for compensating for distortion of an image which is output from a display unit of an image display apparatus, the apparatus comprising: an image reading unit which reads an output image which is output from the display unit; an image comparison unit estimating a difference between image characteristics of the read output image and image characteristics of an input image and creating compensation information which compensates for the difference; and a compensation unit which compensates for distortion of the output image by correcting an original image using the compensation information.

According to another aspect of the present invention, there is provided a method for compensating for distortion of an image which is output from a display unit of an image display apparatus, comprising: reading an output image which is output from the display unit; estimating a difference of image characteristics between the read output image and an input image and creating compensation information for compensating the difference; and compensating for distortion of the output image by correcting an original image by using the compensation information.

### BRIEF DESCRIPTION OF THE DRAWINGS

The above and other aspects of the present invention will become more apparent by describing in detail exemplary embodiments thereof with reference to the attached drawings in which:

FIG. 1 is a view of a basic method of driving a backlight of a field sequential display apparatus according to the related art;

FIG. 2 is a view of a driving method using scrolling backlight of a field sequential display apparatus according to the related art;

FIG. 3 is a schematic cross-sectional view of a display apparatus including a barrier rib preventing color mixture according to the related art;

FIG. 4 is an example of an image displayed on a display apparatus of FIG. 3;

FIG. 5 is a block diagram of an apparatus for compensating for image distortion according to an exemplary embodiment of the present invention;

FIGS. 6A and 6B are views of an input image and an output image which are input to and output from an apparatus for compensating for image distortion according to an exemplary embodiment of the present invention;

FIG. 7 is a view of a process of creating compensation information by an apparatus for compensating for image distortion according to the present invention; and

FIG. 8 is a flowchart of a method of compensating, for image distortion according to an exemplary embodiment of the present invention.

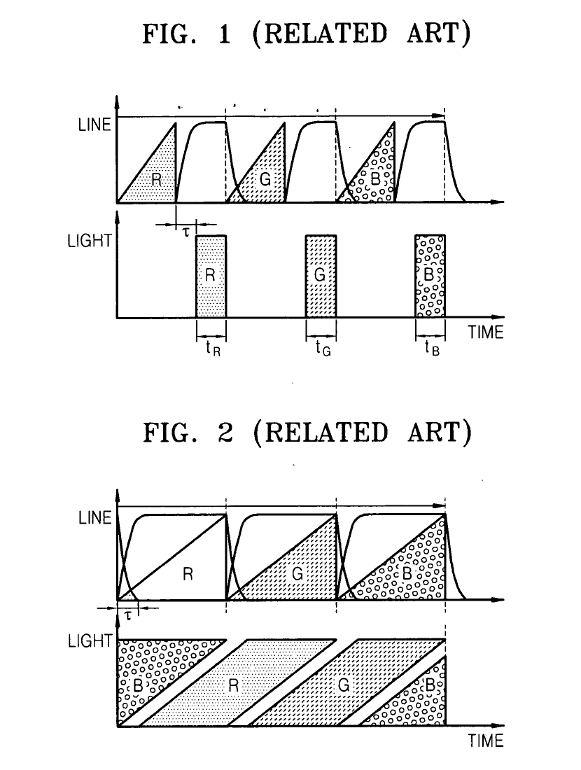

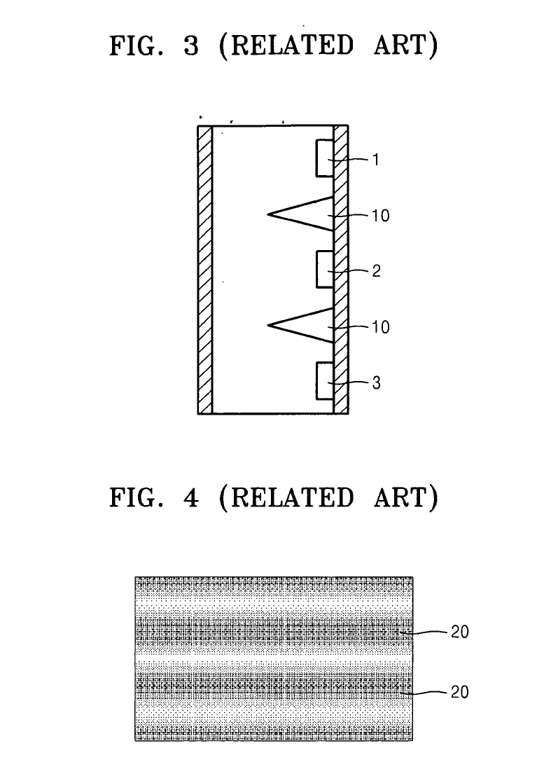

### DETAILED DESCRIPTION OF THE EXEMPLARY EMBODIMENTS OF THE INVENTION

Hereinafter, exemplary embodiments of the present invention will be described in detail with reference to the accompanying drawings.

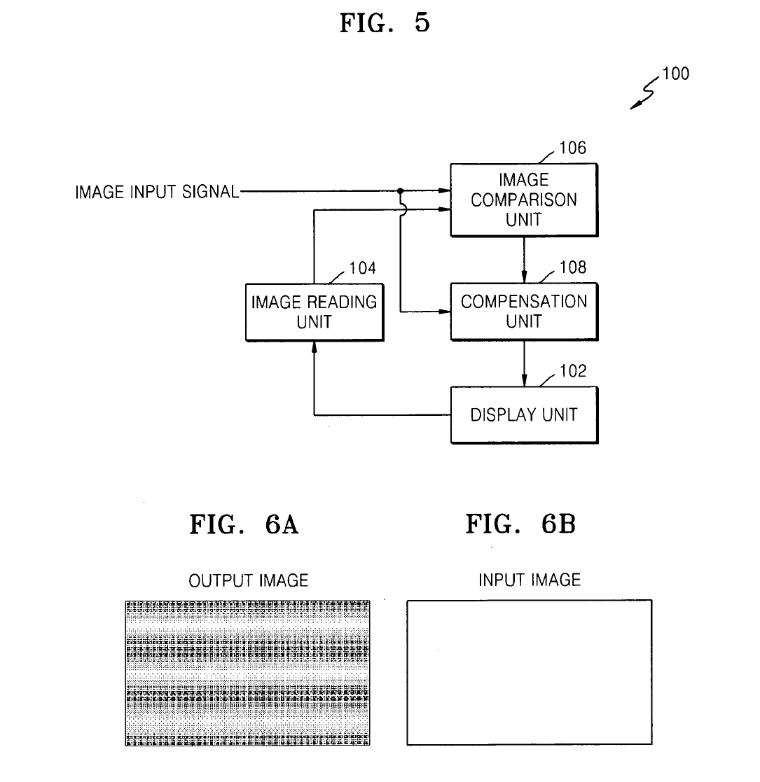

FIG. 5 is a block diagram of an apparatus for compensating for image distortion according to an exemplary embodiment of the present invention.

Referring to FIG. 5, an apparatus 100 for compensating image distortion includes a display unit 102, an image reading unit 104, an image comparison unit 106, and a compensation unit 108.

The display unit 102 displays an input image signal after the image signal has been processed by a predetermined process to be described later in the image comparison unit 106 and the compensation unit 108. In general, the display unit 102 includes a liquid crystal, a backlight lighting the liquid crystal, and an inverter driving the backlight. In this case, to drive the backlight, the inverter, which receives DC power from a specific power supply unit, supplies power to the backlight after converting the supplied DC power to AC power. When supplying the power to the backlight, the inverter reduces or amplifies the voltage of the DC power supplied by the power supply unit, and supplies the power to the backlight. In addition, the inverter may apply a voltage to the backlight such that the backlight is driven using a field sequential drive method. Since detailed configurations and operations of the display unit 102 are well known, detailed descriptions for configurations and operations of the display unit will be omitted.

The image reading unit 104 reads an image signal which is output from the display unit 102. The image reading unit 104 may read an image signal output from the display unit 102 using an image reading apparatus such as a camera, or may read an output image signal by processing an image signal transferred to the display unit 102. The output image signal read by the image reading unit 104 is output to the image comparison unit 106.

The image comparison unit 106 compares an original input image signal with the output image signal input from the image reading unit 104 so as to compare a difference of image characteristics between the two signals. Next, based on the difference between the image characteristics, the image comparison unit 106 creates compensation information for compensating for an area where an output image is distorted, and outputs the compensation information. For example, the image comparison unit 106 compares a difference of luminance level between the input image signal and the output image signal to estimate a degree of uniformity of an image which is output from the display unit 102, and then creates compensation information which compensates for the difference to be output.

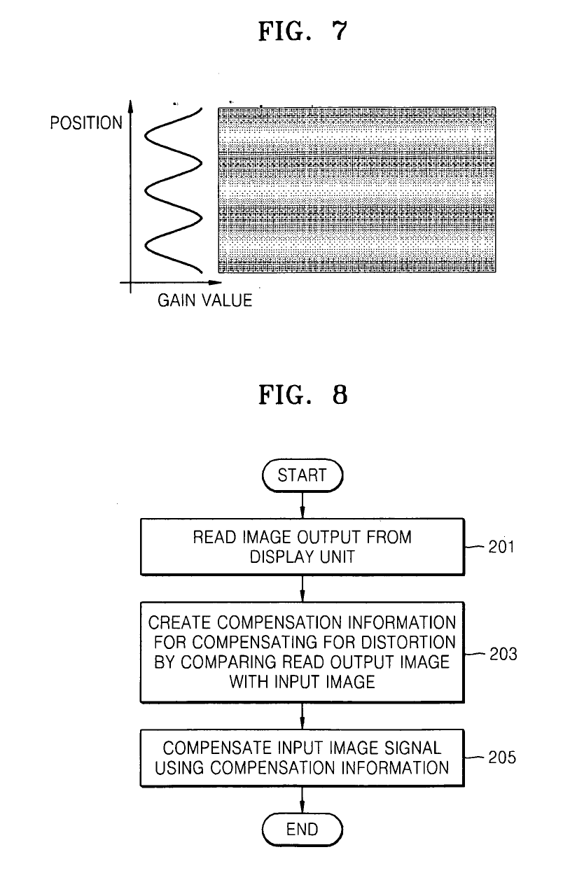

FIG. 6B is a view of an input image and FIG. 6A is an output image which are input to and output from, respectively, an apparatus for compensating for image distortion according to an exemplary embodiment of the present invention. FIG. 7 illustrates a process of creating compensation information, which is used by an apparatus for compensating for image distortion according to the present invention.

Referring to FIGS. 6A and 6B, as described above, in a field sequential display apparatus, a barrier rib is placed between each light source to prevent a color mixture of light sources of R, G, and B. Since a portion of an output image where the barrier rib is placed has less light than output images of other areas, luminance is reduced, thereby making it different from an original input image. Thus, the image comparison unit 106 estimates the difference of image characteristics between the output signal and the input signal, for example, a luminance difference, and creates compensation information for compensating the input image by using the difference, so that the output image can closely resembling the input image.

Referring to FIG. 7, in order to compensate for a portion of the output image where luminance is reduced due to the barrier rib, the compensation information is created such that a portion having low luminance has a higher gain value than other portions.

Using the compensation information output from the image comparison unit 106, the compensation unit 108 removes a distortion area created in the output image by using the compensation information with respect to the input image signal. Namely, the compensation unit 108 compensates the input image signal to reduce image distortion occurring when the input image signal is output. For example, in order to make an output image portion having reduced luminance due to the barrier rib in the field sequential display apparatus closely resemble the input image, the compensation unit 108 amplifies the luminance level of a portion corresponding to the portion having reduced luminance among the input image signals, by using compensation information of the gain value of FIG. 7. Then, among output images which are output from the display unit 102, the luminance level of the portion having reduced luminance due to the barrier rib is compensated, thereby obtaining the output image closely resembling to the input image.

FIG. 8 is a flowchart of a method of compensating for image distortion according to the present invention.

Referring to FIG. 8, the image reading unit 104 reads an image which is output from the display unit 102 (operation 201).

The image comparison unit 106 compares the read output image and an input image so as to detect a distorted portion of the output image, where the output image is different from the input image. As described above, the image comparison unit 106 can detect the distorted portion by estimating the difference of image characteristics between the input and output images. In addition, the image comparison unit 106 creates compensation information to compensate for the distorted portion (operation 203).

The compensation unit 108 compensates the input image signal by using the compensation information to remove the distorted portion of the output image (operation 205).

Accordingly, the present invention provides an image closely resembling to an original input image by compensating image distortion of a display apparatus. In addition, image quality of a liquid crystal display apparatus can be improved by removing varying luminance which may occur on a panel of the liquid crystal display apparatus.

Meanwhile, the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments described herein should be considered in a descriptive sense only and not for purposes of limitation.

What is claimed is:

1. An apparatus for compensating for distortion of an image which is output from a display unit of an image display apparatus, the apparatus comprising:
an image reading unit which reads an output image which is output from the display unit;
an image comparison unit which estimates a difference between image characteristics of the read output image and image characteristics of an input image, and generates compensation information for compensating for the difference; and
a compensation unit which compensates for distortion of the output image using the compensation information generated by the image comparison unit.

2. The apparatus of claim 1, wherein the image comparison unit compensates for the distortion of the output by correcting an original image using the compensation information.

3. The apparatus of claim 2, wherein the image comparison unit estimates the difference by estimating a difference between a luminance level of the original image and a luminance level of the output image.

4. The apparatus of claim 2, wherein the image comparison unit generates the compensation information such that a portion having reduced luminance in the output image such that a gain value of the portion having the reduced luminance is greater than a gain value of other portions.

5. The apparatus of claim 2, wherein the display unit comprises a liquid crystal apparatus which is driven using a field sequential drive method.

6. The apparatus of claim 2, wherein the image reading unit reads the output image using a camera.

7. A method for compensating for distortion of an image which is output from a display unit of an image display apparatus, the method comprising:
reading an output image which is output from the display unit;
estimating a difference of image characteristics between the read output image and an input image;
generating compensation information for compensating the difference; and
compensating for distortion of the output image using the compensation information.

8. The method of claim 7, wherein the compensating for distortion of the output image comprises compensating for the distortion of the output image by correcting an original image using the compensation information.

9. The method of claim 8, wherein the difference of image characteristics is a difference of a luminance level between the original image and the output image.

10. The method of claim 8, wherein the compensation information is generated such that a portion having reduced luminance in the output image has a greater gain value than other portions.

11. The method of claim 8, wherein the display unit comprises a liquid crystal device which is driven using a field sequential drive method.

12. The method of claim 8, wherein the output image is read using a camera.

13. A computer-readable medium having stored thereon a computer program, wherein the program performs a method for compensating for distortion of an image which is output from a display unit of an image display device, the method comprising:
reading an output image which is output from the display unit;
estimating a difference of image characteristics between the read output image and an input image;
generating compensation information for compensating the difference; and
compensating for distortion of the output image using the compensation information.

14. The computer-readable medium of claim 13 having stored thereon the computer program performing the method, wherein the compensating for distortion of the output image comprises compensating for the distortion of the output image by correcting an original image using the compensation information.
